(19) United States
(12) Patent Application Publication
(10) Pub. No.: US 2010/0169317 A1
(43) Pub. Date: Jul. 1, 2010

(54) Product or Service Review Summarization Using Attributes

(75) Inventors: Ye-Yi Wang, Redmond, WA (US); Sibel Yaman, Walnut Creek, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/346,903

(22) Filed: Dec. 31, 2008

(51) Int. Cl. G06F 17/30

(52) U.S. Cl. 707/736; 707/E17.046

(57) ABSTRACT

Described is a technology in which product or service reviews are automatically processed to form a summary for each single product or service. Snippets from the reviews are extracted and classified into sentiment classes (e.g., as positive or negative) based on their wording. Attributes are assigned to the reviews, e.g., based on term frequency concepts, as nouns, which may be paired with adjectives and/or verbs. The summary of the reviews belonging to a single product or service is generated based on the automatically computed attributes and the classification of review snippets into attribute and sentiment classes. For example, the summary may indicate how many reviews were positive (the sentiment class), along with text corresponding to the most similar snippet based on its similarity to the attributes (the attribute class).

### BACKGROUND

Electronic commerce over the Internet is becoming more and more popular, with more and more products and services being offered online. The types of products and services vary; well known examples include consumer electronic products, online travel services, restaurant reservations, and so forth.

Many of these products and services are accompanied by customer reviews that provide valuable information not only to other customers in making a choice, but also to product manufacturers and service providers in understanding how well their products are received.

For many popular products and services, hundreds of reviews are often available, e.g., a website like MSN shopping may have hundreds of customer reviews of the same product. As a result, Internet users are often overloaded with information. Summarizing such reviews would be very helpful. However product/service review summarization poses a number of challenges different from the ones in general-purpose multi-document summarization. For one, unlike summarization of news stories that contain mostly descriptions of events, multiple reviews for the same product/service often contain contradictory opinions. Second, reviews often contain opinions regarding different aspects of a specific category of products/services. For example, sound quality and remote control capabilities apply to DVD players, but food quality and ambience apply to restaurants. At the same time, the frequency of the occurrence of such concepts in reviews varies drastically, whereby sentence extraction summarization based on frequency information does not produce good results.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which review data corresponding to a product or service is automatically processed into a summary. In one aspect, snippets from the reviews are obtained, which may be classified (e.g., as positive or negative based on their wording). Also, attributes are assigned to the snippets, e.g., based on term frequency concepts. The summary of the review data is generated based on the classification data and the assigned attributes. For example, the summary may indicate how many reviews were positive, along with text corresponding to the most similar snippet based on an attribute similarity score.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for attribute-based summarization.

FIG. 2 is a representation of a distribution showing counts of various attributes that are used in multiple reviews.

FIG. 3 is a representation of a hierarchical clustering tree for various restaurant-related attributes.

FIG. 4 is a flow diagram showing general steps in attribute-based summarization.

FIG. 5 shows an illustrative example of a computing environment into which various aspects of the present invention may be incorporated.

### DETAILED DESCRIPTION

Various aspects of the technology described herein are generally directed towards using attributes for review summarization, where attributes are generally concepts related to products and services that appear in their respective reviews, (e.g., sound quality, remote control for DVD players, or food quality, ambience, for restaurants). As will be understood, attribute-based review summarization processes a summary according to a set of attributes and provides aggregated assessments on the attributes. Using a data driven approach, the attributes are automatically identified for a product/service category, which can optionally be manually verified/corrected.

While various examples are used herein, it should be understood that any of these examples are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and the internet in general.

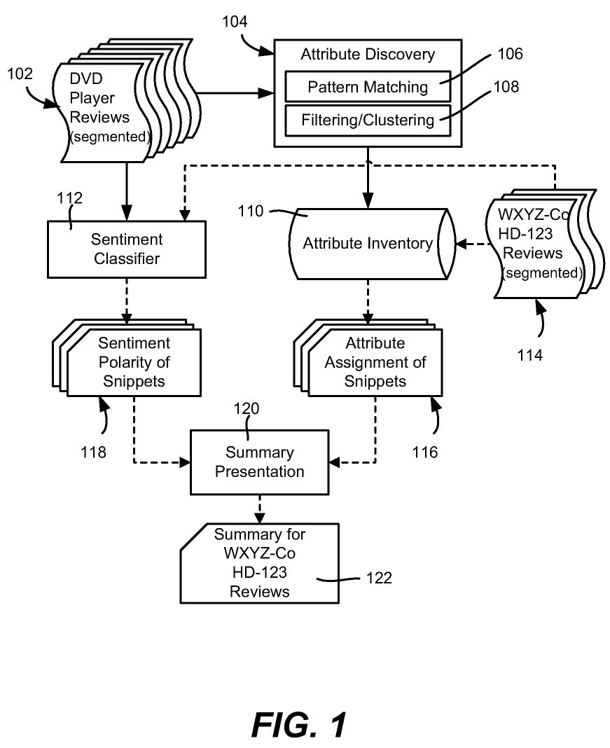

FIG. 1 shows various aspects related to components and/or steps used in a summarization workflow. Note that in FIG. 1, solid arrows represent a training phrase workflow, while dashed arrows represent the workflow in an operational phase.

During the training phase, segmented snippets 102 from the various reviews of the products/services in a category of interest are matched via an attribute discovery mechanism 104 against a predefined set of part-of-speech based patterns (block 106) to harvest candidate attribute names. The candidates are filtered and clustered (block 108), and the resulting clusters stored in an attribute inventory 110. Further, the snippets 102 are used to train a statistical classifier for sentiment classification.

For example, in one implementation, sentiment classification is performed via a known maximum entropy (MaxEnt) classifier (one that takes unigrams and bigrams in a snippet as input features and outputs the posterior probabilities for the binary sentiment polarities) for sentiment classification. Such a classifier may be trained using training data such as:

| | |
|---|---|
| The food is very delicious | Positive |
| I like their filet mignon | Positive |
| The service is terrible | Negative |
| Amy is very friendly | Negative |

In an operational phase, the snippets 114 in the reviews for a product/service are assigned to an attribute (block 116) and labeled (block 118) with a sentiment (e.g., POSITIVE or NEGATIVE) by the classifier 112. From there, a presentation module 120 generates aggregated opinions for each attribute and picks (or synthesizes) a representative snippet from the original reviews for a summary 122.

Thus, instead of applying frequency-based sentence extraction for summarization, readers are presented with aggregated opinions along some attributes that are specific to a category of products (e.g., DVD players) or services (e.g., restaurants). These are augmented with representative snippets taken from original reviews. Examples of typical summaries may be:
68 of the 123 reviews on the overall product are negative.

“I wouldn't say this is a bad DVD player but be careful.”
5 of the 7 reviews on remote control are negative.

“This XYZ model 600 will not work with my universal remote control.”
5 of the 8 reviews on video quality are negative.

“After ten days the sound worked but the video quit working.”

As described in detail below, the segmented snippets in a review are assigned with one of the attributes and a sentiment polarity (positive vs. negative), and a summary is constructed based on these assignments. More particularly, the following description provides additional details on the data-driven approach to mine a set of attributes related to a particular category of products or services; on a statistical classifier that does not require any manually labeled data to detect the sentiment polarity regarding each attribute in the reviews; and an on objective measure for the evaluation of the fidelity of a review summary.

Automatic mining (induction) of the product/service category-specific attributes from review data includes Part-of-speech (POS) tagging of review snippets, and extracting candidate attribute name/adjective pairs with POS-based patterns. In one implementation, automatic mining further includes frequency-based pruning of the candidate attributes, representing a candidate attribute with the distribution of adjectives that co-occur with the attribute and/or automatically clustering of attribute names in terms of the adjective distributions.

Attribute discovery for a given category of products/services is generally performed in two steps, namely data-driven candidate generation followed by candidate filtering/clustering. Attribute candidates are found generally based on the assumption that there are nouns or compound nouns that often appear in some common patterns in reviews. Those patterns may be expressed in terms of part-of-speech (POS) tags, which are well known in the art, e.g., NN represents a noun (NNS stands for nouns or a consecutive noun sequences, that is, compound nouns), CC represents a coordinating conjunction (such as “and”), JJ represents an adjective, JJR represents a comparative adjective, and so forth.

The following sets are an example set of patterns that may be used, together with example matching snippets taken from reviews.
1. NNS CC NNS is (JJ|JJR)

The sound and picture quality are good.
2. NNS is (JJ|JJR)

The sound quality is great
3. NN (is|has) the JJS|RBS NNS

This player has the best picture quality.
4. NNS is the JJS|RBS

The sound quality is the best.
5. NN (is|has) JJR NNS

This player had better sound quality.
6. NNS (is|has) JJR than NN

The xBook design is better than XXX.
7. NNS is JJ CC JJ

Picture quality is great and flawless.
8. $overall (is|has) JJ where $overall ∈{“it”, “this” “I”, $brand}

It/this/WXYZ is great.

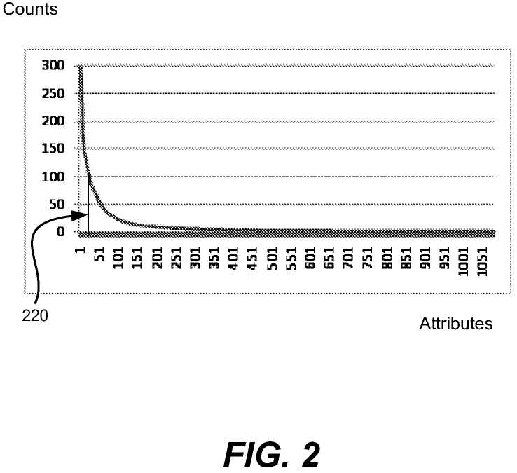

The following example table taken from actual review data shows snippets matching one of the patterns and the number of unique candidate attributes, indicated as the number of total snippets, number and percentage of the snippets that match one of the patterns, and the unique candidate attribute names (noun or compound nouns that match the patterns) for two different domains, namely restaurants and DVD players. The distribution of attribute candidates follows a power law (FIG. 2), in which some of the attributes occur frequently, while a majority of candidates occurs only once or twice.

| Domain | Snippets | Matches | % | Attributes |
|---|---|---|---|---|
| Restaurants | 306,145 | 34,279 | 11.2 | 3,867 |
| DVD Players | 81,513 | 8,710 | 10.7 | 1,996 |

The nouns or compound nouns (e.g., sound, picture quality, sound quality, xBook design and so forth) are attribute candidates. Thousands of such attributes are possible, but are too many to be included in a summary. However, because the candidates are power law distributed, a majority of candidates can be pruned. In fact, those less frequent attributes are often noisy terms, (e.g., “Amy” as a waitress's name), special case of a general attribute (e.g., “beef bbq” vs. “food”) and typos (e.g., “abience” for “ambience”).

In one implementation, the attribute discovery mechanism selects the attributes until they cover half of the area under the curve (represented by the vertical line 220 in FIG. 2), that is, fifty percent of the area under the distribution curve is covered. In one example, this resulted in nineteen attribute names for restaurant reviews, and twenty-six attribute names for DVD player reviews.

There are still many overlaps among these remaining attributes, and thus automatic clustering is used to group the overlapping attributes. To facilitate that, the distribution of the “adjectives” (JJ, JJR, JJS and RBS) that co-occur with an attribute in matching patterns is used to represent the attribute. To this end, an agglomerative hierarchical clustering algorithm is applied, in which initially each attribute forms its own cluster, and then iterative procedures are subsequently invoked to greedily merge the two closest clusters.

By way of example, different attribute candidates may be associated with different adjective distributions:

| | delicious | great | friendly | tasty | prompt | nice | cold | arrogant | terrible |
|---|---|---|---|---|---|---|---|---|---|
| food | 200 | 300 | 1 | 160 | 3 | 200 | 45 | 0 | 40 |
| waiter | 0 | 120 | 173 | 0 | 40 | 180 | 7 | 70 | 50 |
| server | 0 | 200 | 243 | 0 | 60 | 210 | 9 | 53 | 31 |
| pizza | 198 | 340 | 0 | 321 | 5 | 190 | 60 | 0 | 70 |

From this table, the system may construct numerical representations for the attributes, e.g.,:

| | | | | | | | | | |
|---|---|---|---|---|---|---|---|---|---|
| food: | (0.210748 | 0.316122 | 0.001054 | 0.168599 | 0.003161 | 0.210748 | 0.047418 | 0 | 0.04215) |
| Waiter: | (0 | 0.1875 | 0.270313 | 0 | 0.0625 | 0.28125 | 0.010938 | 0.109375 | 0.078125) |
| Server: | (0 | 0.248139 | 0.301489 | 0 | 0.074442 | 0.260546 | 0.011166 | 0.065757 | 0.038462) |
| Pizza: | (0.16723 | 0.287162 | 0 | 0.271115 | 0.004223 | 0.160473 | 0.050676 | 0 | 0.059122) |

Note that by comparing the four distribution vectors, waiter and server may be put in a common cluster, food and pizza in a common cluster, and so forth.

In one implementation, two different known metrics are used to measure the distance between two attribute clusters A₁ and A₂, including the loss of mutual information between A and J caused by a merge, where A is a random variable of attribute clusters and J is a random variable of adjectives:

$${Dis}_{1} ( {A}_{1} , {A}_{2} ) = {MI}_{A \hat{I} C} ( A ; J ) - {MI}_{A \hat{I} C - {A}_{1} - {A}_{2} + [ {A}_{1} , {A}_{2} ]} ( A ; J )$$

Another metric is the known Kullback-Leibler (KL) distance between two attributes:

Dis₂(A₁,A₂)=D(p_{A}_{₁}Pp_{A}_{₂})+D(p_{A}_{₂}Pp_{A}_{₁}).

Here C stands for a set of clusters, [A₁,A₂] stands for the cluster formed by merging A₁ and A₂, D(·P·) is the KL-divergence, and p_{A}_{₁}, p_{A}_{₂} represent the distribution of adjectives associated with A₁ and A₂, respectively. After each merge, the distribution is re-estimated for the merged cluster.

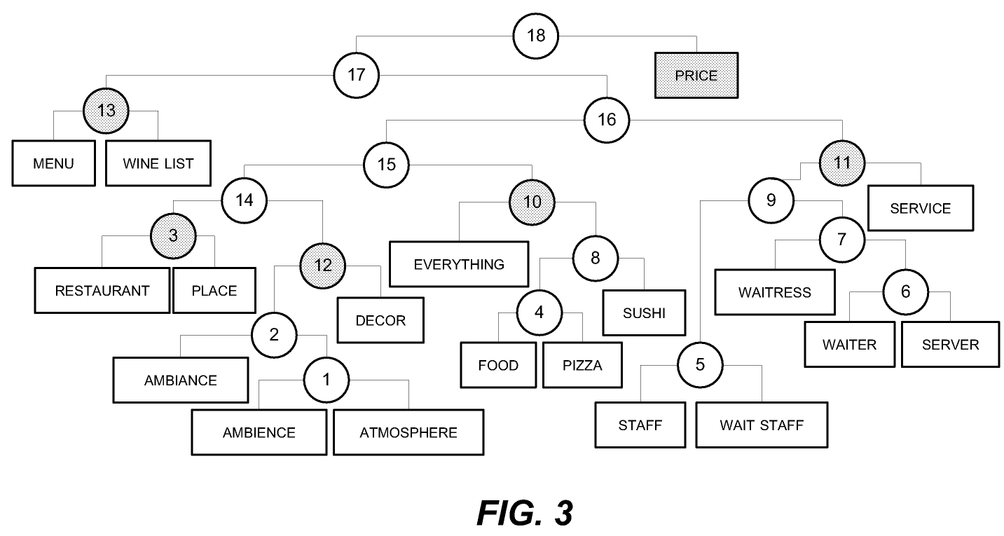

In general, the KL-distance metric produces intuitively better clusters than the loss of mutual information metric. As one example, FIG. 3 shows a cluster hierarchy for the nineteen attributes from restaurant reviews, in which the numbers indicate the iteration at which the children are merged. The smaller the number is, the closer the children nodes are. By varying the stop time for cluster merging, the length of a summary can be controlled. In general, the earlier cluster merging is stopped, the more detailed and lengthy the summaries that are generated. While this can be automatically determined, supervision may be used to determine when to stop cluster merging, and to move clusters around to produce more intuitive clusters. For DVD player reviews, the attribute candidate “color” was automatically merged with “battery life” first and then with the quality related cluster in automatic clustering, which is corrected and moved to the “image quality” cluster.

In the example of FIG. 3, if cluster merging is stopped at step (iteration) fourteen, six clusters (shaded) remain, which respectively represent price, menu choices, overall, ambience, food quality and service, which are common attributes that people care about. The success of clustering results in part from the large amount of data (e.g., more than 34,279 attribute-adjective pairs because some patterns may associate more than one adjective to an attribute) for a small number of attributes.

Clustering DVD player attributes can be more challenging because less data is available for a bigger set of attribute names. A heuristic may be applied to pre-merge two attributes if one is a prefix of another. For example, this results in the following initially merged clusters: {menu, menu system}, {image, image quality}, {audio, audio quality}, {picture, picture quality}, {sound, sound quality}, {video, video quality}, {battery, battery life}. The automatic clustering algorithm is subsequently applied, which results in 14 clusters that span six major areas: quality (audio & video, etc), service, ease-of-use (remote, setup, menu), price, battery life, and defects (problems, disc problems.)

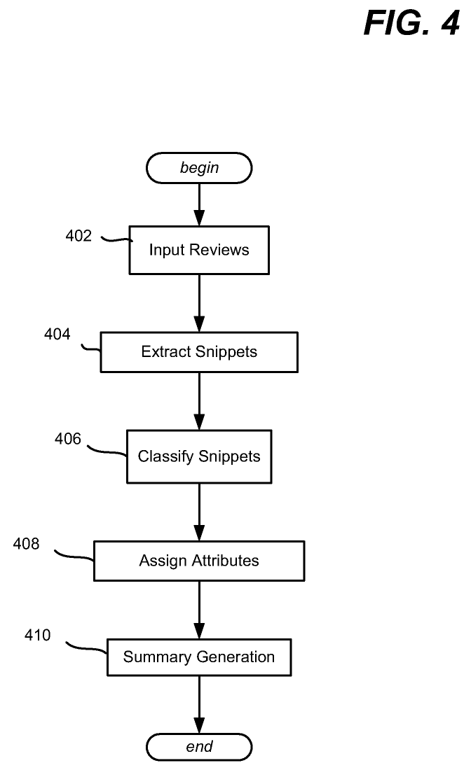

FIG. 4 shows various general steps of attribute-based summarization beginning at step 402 where the reviews to be processed are input into an attribute-based summarization system. Step 404 represents extracting the snippets.

As represented by step 406, the sentiment classifier 112 (FIG. 1) performs sentiment classification for review snippets based on the overall score assigned to a product by the same reviewer in one implementation. As described above, in one implementation, sentiment classification is performed via a known maximum entropy (MaxEnt) classifier.

Overall scores are used because labeled data are required for MaxEnt model training, and it is not practical to manually assign a sentiment polarity to every snippet in the reviews. In an implementation in which each review is accompanied by an overall score ranging from 1 to 5 assigned by the reviewers, a sentiment polarity label is assigned to each snippet in the corresponding review, such as if the score is 4 or 5, a POSITIVE label is assigned to all snippets in the review, otherwise a NEGATIVE label is assigned:

| | |
|---|---|
| Review 1. Overall score 4-5 | Review 2. Overall score 1-3 |

| | | | |
|---|---|---|---|
| Snippet 1 | Positive | Snippet 1 | Negative |
| Snippet 2 | Positive | Snippet 2 | Negative |
| . . . | . . . | . . . | . . . |
| Snippet k | Positive | Snippet n | Negative |

Other implementations may be used, e.g., 4 or 5 is POSITIVE, 1 or 2 is NEGATIVE, 3 is discarded. In any event, while this is an approximation, the data redundancy across different reviews tends to smooth out the noise introduced by the approximation.

Turning to attribute assignment (step 408 of FIG. 4), only around ten percent of the total snippets are matched with attribute patterns, while half of them are discarded by candidate filtering. While this works well for attribute discovery in which reviews for multiple products in the same category are agglomerated, this may not be sufficient to obtain attribute sentiment statistics and/or to pick a representative snippet of an attribute for a single product. Therefore, a process is used to determine what attribute or attributes a snippet is describing when the snippet does not match a prescribed pattern.

One solution is to look for attribute names in a snippet. If an attribute name is found, regardless of whether the snippet matches a pattern or not, the attribute cluster to which the name belongs is assigned to the snippet. This approach, referred to as “keyword matching,” does not take into account the frequency information of an attribute name nor the adjectives that co-occur with the attribute names.

An alternative approach uses the known TF-IDF (term frequency-inverse document frequency) weighted vector space model, which in general represents an attribute (cluster) with a TF-IDF weighted vector of the terms including attribute names, the co-occurring adjectives and (optionally) the co-occurring verbs. More particularly, each attribute is represented by a vector of TF-IDF weights of terms. A snippet is also represented by a TF-IDF weighted vector, and the cosine between the two vectors is used to measure the similarity between the snippet and the attribute. The attribute most similar to the snippet is then assigned to the snippet.

Thus a vector is constructed for each attribute:
A=(x₁, x₂, . . . ,xₖ), where xᵢ stands for the TF-IDF feature for the i^{th} term in the vocabulary. Similary, a TF-IDF feature vector is formed for each snippet as

S=A=(x₁, x₂, . . . ,xₖ).

The similarity of a snippet to an attribute can be measured with the cosine of the angle formed by the two TF-IDF feature vectors in the k-dimensional space, i.e.,

$$Similarity α Cos ( A , S ) = \frac{A \cdot S}{\vert A \vert \cdot \vert S \vert} ,$$

where |.| denotes the norm of a vector.

In one implementation, different lexical entries can be used as the “terms” in the TF-IDF vector in the following three settings:
Words in the attribute names of an attribute cluster (e.g., food, pizza, sushi).
Words in the attribute names and the adjectives that co-occur with the attribute (e.g. food, pizza, sushi, great, delicious, tasty, . . . ).
Words in attribute names, adjectives, and the verbs that co-occur with the attribute names and adjectives in snippets that match a pattern (e.g., food, pizza, sushi, great delicious, tasty, . . . , taste, enjoy, . . . ).

Turning to the summary generation (step 410 of FIG. 4), after sentiment classification (step 406) and attribute assignment (step 408), the aggregated opinion for each attribute may be generated, one-by-one, until the summary reaches a length limit. The most frequent attributes in the reviews are selected first. Among the snippets that have the same sentiment as the majority sentiment for an attribute from different reviews, the one that bears the highest similarity with the attribute vector is selected as the representative one for the attribute in the summary 122. Thus, the selection of attribute-representative snippets is based on the confidence scores of sentiment classification and attribute assignment. Note that it is feasible to synthesize a summary via the attribute vector.

As can be readily appreciated, training, classification, attribute assignment and/or summary presentation may provide varying results depending on what system is selected for use in generating the reviews. Evaluation metrics for the fidelity of a summary may be used to determine what system works best, e.g., one system may work well for electronic products, while another works well for restaurants.

For example, multiple users (or even a single user) can read one system's summary for evaluation purposes, each providing a score of what they understood the summary to have conveyed, resulting in a summary score. This summary score (e.g., an average) may be evaluated against the actual average scores given by users in their reviews to determine which system works best, e.g., based on the distribution of a subject-assigned score and mean square error to select which system is better than the other or others.

### Exemplary Operating Environment

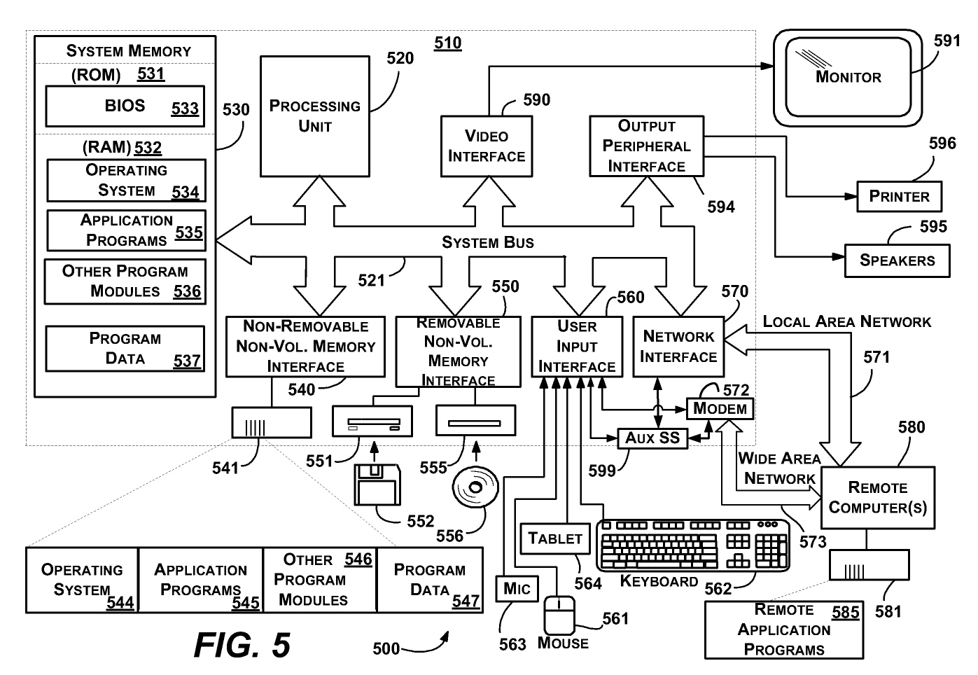

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, processing review data corresponding to a product or service, including automatically obtaining an inventory of attributes for a product or service category, obtaining review snippets from the review data, classifying the review snippets into classification data, assigning attributes to the review snippets, and generating a summary of the review data based on the classification data and the assigned attributes.

2. The method of claim 1 wherein automatically obtaining the inventory comprises representing the review snippets using part of speech tagging, and extracting candidate attributes including name, adjective pairs with part of speech-based patterns.

3. The method of claim 2 further comprising, pruning the candidate attributes based on frequency.

4. The method of claim 2 further comprising, representing a candidate attribute based upon distributions of the adjectives that co-occur with the attribute.

5. The method of claim 4 further comprising, clustering attribute names based upon distributions of the adjectives.

6. The method of claim 1 wherein classifying the review snippets comprises performing sentiment classification for review snippets based on an overall score associated with the review snippets.

7. The method of claim 1 wherein assigning the attributes to a review snippet comprises applying a TF-IDF weighted vector space model.

8. The method of claim 1 further comprising, representing a cluster of at least one attribute with a TF-IDF weighted vector of terms therein, including attribute names, and co-occurring adjectives.

9. The method of claim 8 wherein representing the cluster further comprises representing at least one co-occurring verb.

10. The method of claim 1 wherein generating the summary comprises selecting a representative snippet based on confidence scores from classification and attribute assignment.

11. The method of claim 1 further comprising, processing evaluation metrics indicative of fidelity of a summary.

12. In a computing environment, a system comprising, a classification mechanism that classifies snippets of reviews into sentiment scores for each snippet, an attribute assignment mechanism that assigns attributes to each snippet, and a summary generation mechanism that outputs a summary based on the sentiment score and assigned attributes for a snippet.

13. The system of claim 12 wherein the classification mechanism comprises a maximum entropy model.

14. The system of claim 12 wherein the attribute assignment mechanism comprises a term-frequency, inverse document frequency model that compares snippet vectors against attribute vectors to determine similarity.

15. The system of claim 12 wherein the summary generation mechanism outputs information corresponding to sentiment classification and text based upon a representative snippet.

16. One or more computer-readable media having computer-executable instructions, which when executed perform steps, comprising: summarizing a set of reviews, including determining a set of attributes corresponding to review data, determining similarity between review data and the set of attributes, and providing a summary based upon the similarity.

17. The one or more computer-readable media of claim 16 having computer-executable instructions comprising, classifying reviews into classification sentiment data, and wherein providing the summary further comprises, outputting information based upon the classification sentiment data.

18. The one or more computer-readable media of claim 16 wherein determining the set of attributes comprises using part of speech tagging to extract candidate attributes, and pruning the candidate attributes based on frequency.

19. The one or more computer-readable media of claim 16 wherein the candidate attribute includes at least one adjective that co-occurs with the attribute, or at least one verb that co-occurs with the attribute, or both at least one adjective and at least one verb that co-occur with the attribute.

20. The one or more computer-readable media of claim 16 having computer-executable instructions comprising, clustering at least some of the attributes based upon distributions of co-occurring adjectives.
